(19) United States
(12) Patent Application Publication
(10) Pub. No.: US 2021/0163715 A1
(43) Pub. Date: Jun. 3, 2021

(54) METHOD OF MANUFACTURING ALIPHATIC POLYESTER RESIN COMPOSITION AND PRODUCT CONTAINING THE ALIPHATIC POLYESTER RESIN COMPOSITION

(71) Applicant: Taichi NEMOTO, Shizuoka (JP)

(72) Inventor: Taichi NEMOTO, Shizuoka (JP)

(21) Appl. No.: 17/105,815

(22) Filed: Nov. 27, 2020

(30) Foreign Application Priority Data
Nov. 28, 2019 (JP) 2019-215547
Sep. 30, 2020 (JP) 2020-166209

(51) Int. Cl. C08K 7/18; C08K 3/36; C08K 3/34; C08K 3/22

(52) U.S. Cl. CPC C08K 7/18; C08K 3/36; C08K 2003/2237; C08K 3/22; C08K 3/346

(57) ABSTRACT

A method of manufacturing an aliphatic polyester resin composition is provided. The method includes kneading an aliphatic polyester resin and a filler at a temperature lower than a melting point of the aliphatic polyester resin in the presence of a compressible fluid.

### CROSS-REFERENCE TO RELATED APPLICATIONS

This patent application is based on and claims priority pursuant to 35 U.S.C. § 119(a) to Japanese Patent Application Nos. 2019-215547 and 2020-166209, filed on Nov. 28, 2019 and Sep. 30, 2020, respectively, in the Japan Patent Office, the entire disclosure of each of which is hereby incorporated by reference herein.

### BACKGROUND

### Technical Field

The present disclosure relates to a method of manufacturing an aliphatic polyester resin composition and a product containing the aliphatic polyester resin composition manufactured by the method.

### Description of the Related Art

Aliphatic polyester resins such as polylactic acid and polybutylene succinate are biodegradable. Material development is being actively carried out in connection with the problem of increasing waste in recent years, and there is widespread consideration for replacing non-biodegradable polymers with the aliphatic polyester resins.

On the other hand, there has been a technique of adding a filler to a resin for the purpose of imparting a specific function to the resin, increasing the volume of the resin, and the like.

Addition of the filler may impart, for example, the following functions to the resin: antibacterial property, conductivity, thermal conductivity, piezoelectricity, vibration damping property, sound insulation property, slidability, heat insulating property, electromagnetic wave absorptivity, light reflecting property, light scattering property, heat ray radiation property, flame retardancy, radiation protection, ultraviolet protection, dehumidifying property, dehydrating property, deodorization property, gas absorptivity, anti-blocking property (prevention of film crimping), oil absorptivity (printing ink absorptivity, quick-drying property, etc.), and water absorptivity.

A material in which a resin and a nanoparticle, or a resin and a nanofiber, are composited on a nanoscale is called a nanocomposite. Typical examples of the nanocomposite include a clay-based polymer composite. The clay-based polymer composite is obtained by adding a clay that is a layered compound as a filler to a resin. The clay is delaminated, and each layer is dispersed in the resin, resulting in a composite of the resin and the clay. The nanocomposite has excellent gas barrier properties and mechanical strength as compared with a kneaded product with a micron-order filler because the interface between the resin and the filler has been enlarged.

In addition to the above-described mechanical properties and gas barrier properties, optical properties, electrical properties, flame retardancy, etc., of the resin can be controlled by changing the type of nanoparticle used as the filler.

### SUMMARY

In accordance with some embodiments of the present invention, a method of manufacturing an aliphatic polyester resin composition is provided. The method includes kneading an aliphatic polyester resin and a filler at a temperature lower than a melting point of the aliphatic polyester resin in the presence of a compressible fluid.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a phase diagram showing the state of matter with respect to temperature and pressure;

FIG. 2 is a phase diagram for defining the range of compressible fluid; and

FIG. 3 is a schematic view of a continuous kneading apparatus used for manufacturing the aliphatic polyester resin composition according to an embodiment of the present invention.

The accompanying drawings are intended to depict example embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Embodiments of the present invention are described in detail below with reference to accompanying drawings. In describing embodiments illustrated in the drawings, specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

For the sake of simplicity, the same reference number will be given to identical constituent elements such as parts and materials having the same functions and redundant descriptions thereof omitted unless otherwise stated.

In accordance with some embodiments of the present invention, a method of manufacturing an aliphatic polyester resin composition capable of satisfactorily dispersing a filler is provided.

### Method of Manufacturing Aliphatic Polyester Resin Composition

A method of manufacturing an aliphatic polyester resin composition according to an embodiment of the present invention include kneading an aliphatic polyester resin and a filler at a temperature lower than a melting point of the aliphatic polyester resin in the presence of a compressible fluid.

### Kneading

It is a known technique to knead a plasticized resin and a filler. One method of plasticizing a resin uses a compressible fluid. It is generally known that a compressible fluid plasticizes a resin and reduces the melt viscosity of the resin. A decrease in melt viscosity and improvement in kneadability may appear to be contradictory properties. Actually, in some cases, the filler may be kneaded under pressure without using a compressible fluid. This is aimed at reducing the free volume of the resin and increasing the interaction (viscosity) between the resins. However, such a process of kneading the resin and the filler under pressure without using a compressible fluid has an adverse effect in terms of plasticization of the resin (see “K. Yang. R. Ozisik R. Polymer, 47. 2849 (2006)”).

It is known that the compressible fluid exhibits a plasticizing effect that is a property of plasticizing (softening) a resin and that the resin becomes like a liquid due to a decrease in viscosity by the plasticizing effect. Dispersing the filler in the resin in such a state is like dispersing the filler in a liquid. As a result, the filler aggregates, and a resin composition in which the filler is highly dispersed in the resin cannot be obtained. It has been considered difficult to use a compressible fluid in kneading the resin and the filler because the viscosity of the resin in the presence of the compressible fluid is not suitable for kneading the resin.

The inventors of the present invention have diligently studied whether a compressible fluid can be used in kneading the aliphatic polyester resin and the filler. Here, the aliphatic polyester resin has a property that the viscosity rapidly drops at and above the melting point thereof for its structure. The inventors of the present invention have found that the viscosity of the aliphatic polyester resin in the presence of a compressible fluid becomes suitable for kneading when the temperature is lower than the melting point of the aliphatic polyester resin. The inventors have thus found that it is possible to knead the aliphatic polyester and the filler. In particular, the aliphatic polyester resin whose melt viscosity rapidly drops at and above the melting point can be kneaded only in a low melt viscosity state. According to an embodiment of the present invention, the aliphatic polyester resin can be kneaded with a filler even in a high viscosity state, which is preferable.

The kneading is performed at a temperature lower than the melting point of the aliphatic polyester resin, preferably at a temperature lower than the melting point of the aliphatic polyester resin by 20 degrees C. or more.

When the temperature is equal to or higher than the melting point of the aliphatic polyester resin, the aliphatic polyester resin may become liquid and the filler may aggregate.

For example, when the aliphatic polyester is lactic acid (polylactic acid), since the melting point of polylactic acid is about 180 degrees C., the kneading is performed at a temperature lower than 180 degrees C., preferably at 160 degrees C. or lower. Further, the kneading is preferably performed at 100 degrees C. or higher.

### Compressible Fluid

Examples of substances that can be used in the state of a compressible fluid include, but are not limited to, carbon monoxide, carbon dioxide, dinitrogen monoxide, nitrogen, methane, ethane, propane, 2,3-dimethylbutane, ethylene, and dimethyl ether. Among these substances, carbon dioxide that has a critical pressure of about 7.4 MPa and a critical temperature of about 31 degrees C. is preferable for the ease in creating a supercritical state and for its nonflammability and handleability. Each of these substances can be used alone or in combination with others as the compressible fluid.

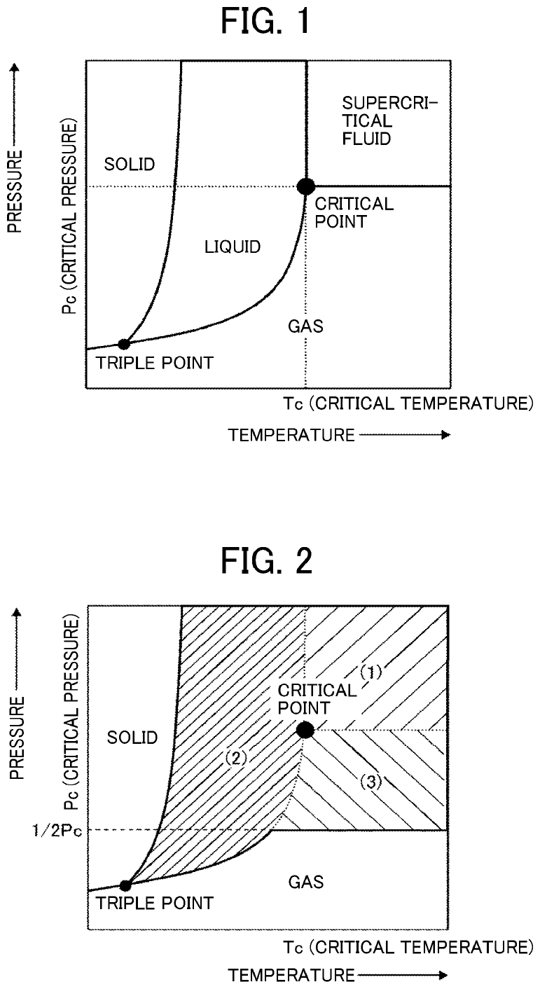

The compressible fluid used for manufacturing the aliphatic polyester resin composition is described in detail below with reference to FIGS. 1 and 2. FIG. 1 is a phase diagram showing the state of matter with respect to temperature and pressure. FIG. 2 is a phase diagram for defining the range of compressible fluid. In the present disclosure, the “compressible fluid” refers to a state of a substance existing in any of the regions (1), (2), or (3) illustrated in FIG. 2, which are defined in the phase diagram of FIG. 1.

It is known that a substance in these regions demonstrates a very high density and the behavior thereof is different from that at normal temperature and pressure. A substance existing in the region (1) is a supercritical fluid. The supercritical fluid is a fluid that exists as a non-condensable high-density fluid at temperatures and pressures above the limit (critical point) of coexistence of a gas and a liquid and that does not condense even when compressed. A substance existing in the region (2) is a liquid, which is a liquefied gas obtained by compressing a substance in a gaseous state at normal temperature (25 degrees C.) and normal pressure (1 atm). A substance existing in the region (3) is in a gaseous state, which is a high-pressure gas whose pressure is ½ (½Pc) or more of the critical pressure (Pc).

In the present disclosure, the pressure at the kneading is preferably the half or more of the pressure of the compressible fluid at the critical point of gas. For example, in the case of carbon dioxide, since the pressure at the critical point is 8 MPa, the pressure at the kneading is preferably 4 MPa or more.

The upper limit of the pressure at the kneading is not particularly limited and can be suitably selected to suit to a particular application as long as it is within the pressure resistance of the apparatus, but is preferably 50 MPa or less.

The amount of the compressible fluid supplied is preferably equal to or less than the solubility of the compressible fluid in the resin, which varies depending on the combination of the types of resin and compressible fluid. For example, in the case of a combination of polylactic acid and carbon dioxide, the proportion of the carbon dioxide supplied to the polylactic acid is preferably 3% by mass or more and 20% by mass or less, and more preferably 5% by mass or more and 10% by mass or less. When the proportion of the carbon dioxide supplied is 3% by mass or more, an undesired phenomenon in which the plasticization effect is limited can be prevented. When the proportion of the carbon dioxide supplied is 20% by mass or less, an undesired phenomenon in which carbon dioxide and polylactic acid are phase-separated and cannot be subjected to uniform kneading can be prevented.

### Aliphatic Polyester Resin

Since the aliphatic polyester resin is biodegradable by microorganisms, it is attracting attention as an environment-friendly low-environmental-load polymer material (see “Structure, physical properties, and biodegradability of aliphatic polyester”, KOBUNSHI (High Polymers, Japan), 2001, Vol. 50, No. 6, p. 374-377).

Examples of the aliphatic polyester resin include, but are not limited to, polylactic acid, polyglycolic acid, poly(3-hydroxybutyrate), poly(3-hydroxybutyrate-3-hydroxyhexanoate), poly(3-hydroxybutyrate-3-hydroxyvalerate), polycaprolactone, polybutylene succinate, and poly(butylene succinate-adipate). Each of these can be used alone or in combination with others. Among these, polylactic acid, which is a relatively inexpensive carbon-neutral material, is preferable as the aliphatic polyester resin.

From the viewpoint of biodegradability, the proportion of the aliphatic polyester resin to the total amount of organic matter in the aliphatic polyester resin composition is preferably 80% by mass or more, more preferably 99% by mass or more.

Here, the organic matter refers to compounds containing a carbon atom excluding carbon oxides and carbonates.

The organic matter can be quantified by the following procedure.

The aliphatic polyester resin composition is analyzed by a simultaneous thermogravimetry-differential thermal analyzer (TG-DTA). Organic matter and inorganic matter are respectively determined by the weight loss and the weight of remaining residue.

### Measurement by TG-DTA

Equipment: TG/DTA Type 320 (manufactured by Seiko Instruments & Electronics Ltd.)

Temperature rising rate: 10 degrees C./min

Temperature: Room temperature to 550 degrees C.

Airflow: Under N₂ atmosphere (200 mL/min)

Sampling volume: 10 mg

Sample container: Pt standard container

### Method of Measuring Proportion of Aliphatic Polyester Resin

The proportion of the aliphatic polyester resin can be calculated from the preparation ratio among materials. If the preparation ratio among materials is unknown, the components can be specified by a GC-MS (gas chromatography-mass spectrometry) analysis under the following measurement conditions, by comparison with a known aliphatic polyester resin as a standard sample. If necessary, other analysis methods, such as an analysis based on the area ratio of an NMR (nuclear magnetic resonance) spectrum, can be combined to calculate the content.

### Measurement by GC-MS Analysis

GC-MS: QP2010 manufactured by Shimadzu Corporation, auxiliary equipment: Py3030D manufactured by Frontier Laboratories Ltd.
Separation column: Ultra ALLOY UA5-30M-0.25F manufactured by Frontier Laboratories Ltd.
Sample heating temperature: 300 degrees C.
Column oven temperature: 50 degrees C. (hold for 1 minute)->temperature rise at 15 degrees C./min->320 degrees C. (6 minutes)
Ionization method: Electron Ionization (E.I.) method
Detected mass range: 25 to 700 (m/z)

Filler

The aliphatic polyester resin dispersing the filler has improved strength and heat resistance. Some types of fillers can also serve as a crystal nucleating agent.

The filler is not particularly limited and can be suitably selected to suit to a particular application. Examples thereof include organic fillers and inorganic fillers. Each of these can be used alone or in combination with others.

Examples of the organic filler include, but are not limited to, aramid fibers, various types of fibers, nanocellulose fibers, and polyoxybenzoyl whiskers.

Examples of the inorganic filler include, but are not limited to, titanium oxide, silica, alumina, wollastonite, potassium titanate, xonotlite, gypsum fibers, aluminum borate, carbon fibers, glass fibers, talc, mica, and glass flakes.

Among these, titanium oxide and silica are preferred as the filler.

The shape of the filler is not particularly limited and can be suitably selected to suit to a particular application, but fillers having a spherical shape are preferred.

The number average particle diameter of the filler in the aliphatic polyester resin composition after kneading is not particularly limited and can be suitably selected to suit to a particular application, but is preferably 0.01 μm or more and 0.20 μm or less, more preferably 0.02 μm or more and 0.10 μm or less.

When the number average particle diameter is 0.01 μm or more and 0.20 μm or less, the filler provides good mechanical properties such as strength without aggregating even when introduced into the aliphatic polyester.

Generally, the smaller the number average particle diameter of the filler (i.e., the finer the filler), the higher the cohesive force of the filler. In the present disclosure, even a small-particle-size filler that has a strong cohesive force can be finely dispersed in the composition as well as a large-particle-size filler, because the effect of the present invention is exerted under the energy conditions (temperature, stirring) required for kneading.

The standard deviation of the number average particle diameter of the filler in the aliphatic polyester resin composition is preferably 0.3 or less, more preferably 0.2 or less. When the standard deviation of the number average particle diameter is 0.3 or less, the filler is not aggregated, so that mechanical properties such as strength are good even when the amount of the filler is increased.

In the present disclosure, coarse particles refer to particles having a particle diameter of 10 μm or more.

The number of coarse particles of the filler having a particle diameter of 10 μm or more is preferably 10 or less, more preferably 3 or less, per 1 mm² of the aliphatic polyester resin composition after kneading. When the number of coarse particles of the filler having a particle diameter of 10 μm or more is 10 or less per 1 mm² of the aliphatic polyester resin composition after kneading, the appearance and physical properties such as strength are good.

### Measurement of Number Average Particle Diameter and Standard Deviation of Filler

The number average particle diameter of the filler, the standard deviation of the number average particle diameter, and the number of coarse particles of the filler having a particle diameter of 10 μm or more, in the aliphatic polyester resin composition, are determined by subjecting a sheet made of the aliphatic polyester resin composition to a cross-section processing using an ion milling device and observing the cross-section with a SEM (scanning electron microscope).

The obtained SEM image of the cross-section (with a magnification of 10,000 times) is binarized into white components, corresponding to the filler, and resin components using a software program IMAGE-PRO PREMIER (made by Media Cybernetics, Inc.). After that, a particle diameter (Feret diameter) of each white component (filler) is determined in a 35 μm 20 μm range in the above image, then the number average particle diameter and standard deviation (σ) are calculated from the white components (filler) which have a Feret diameter of 0.05 μm or more.

The number of coarse particles of the filler can be measured by observing the SEM image of the cross-section.

The preparation ratio (aliphatic polyester resin/filler) of the aliphatic polyester resin to the filler is preferably 99/1 or more and 90/10 or less, more preferably 99.7/0.03 or more and 95/5 or less. When the preparation ratio is 99/1 or more, an undesired phenomenon in which the aliphatic polyester cannot be reformed by the filler can be avoided. When the preparation ratio is 90/10 or less, an undesired phenomenon in which biodegradability of the aliphatic polyester cannot be utilized can be avoided.

The preparation ratio (aliphatic polyester resin/filler) of the aliphatic polyester resin to the filler may also be referred to as the feed ratio.

### Kneading Apparatus

A kneading apparatus used for manufacturing the aliphatic polyester resin composition according to an embodiment of the present invention may employ either a continuous process or a batch process. Preferably, the reaction process is suitably selected considering the apparatus efficiency, the property and quality of the products, etc.

Examples of the kneading apparatus include, but are not limited to, single-screw extruders, twin-screw extruders, kneaders, non-screw cage-type stirring tanks, BIVOLAK manufactured by Sumitomo Heavy Industries, Ltd., N-SCR manufactured by Mitsubishi Heavy Industries, Ltd., glasses-like blades and lattice blades manufactured by Hitachi, Ltd., and tube-type polymerization tanks equipped with Kenix-type or Sulzer-type SMLX static mixer, all of which are applicable to viscosities which are suitable for kneading. In terms of color tone, self-cleaning polymerization equipment such as finishers, N-SCR, and twin-screw extruders can be used. Among these, finishers and N-SCR are preferred for the production efficiency, resin color tone, stability, and heat resistance.

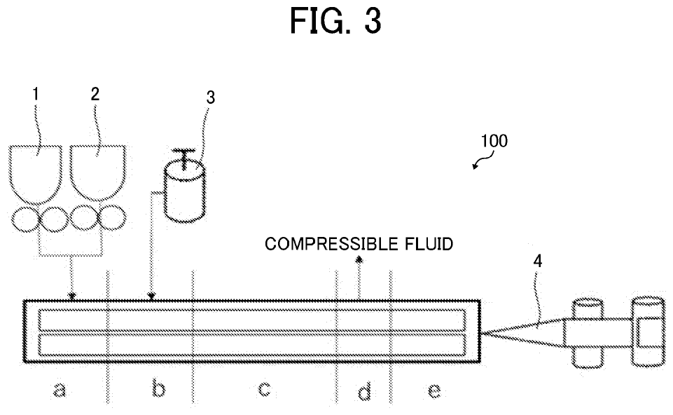

As illustrated in FIG. 3, a continuous kneading apparatus 100 includes a twin-screw extruder 1 (manufactured by The Japan Steel Works, Ltd., having a screw diameter of 42 mm and L/D=48), a device 2 providing a raw material mixing and melting area (a), a device 3 providing a compressible fluid supply area (b), a kneading area (c), a compressible fluid removal area (d), a mold processing area (e), and a T-die 4. A compressible fluid (liquid material) is supplied using a metering pump. Solid raw materials such as resin pellets and calcium carbonate are supplied using a quantitative feeder.

### Raw Material Mixing and Melting Area

In the raw material mixing and melting area, a resin pellet and a filler are mixed, and the temperature is raised. The heating temperature is set to be equal to or higher than the melting temperature of the resin so that the resin can be uniformly mixed with the compressible fluid in the subsequent compressible fluid supply area.

### Compressible Fluid Supply Area

In the compressible fluid supply area, the resin pellet is melted by heating, and the compressible fluid is supplied while the filler is in a wet state, so that the melted resin is plasticized.

### Kneading Area

The temperature of the kneading area is set so that the viscosity becomes suitable for kneading the filler. The set temperature is not particularly limited and varies depending on the specifications of the reactor, the type, structure, molecular weight, etc., of the resin. For example, a commercially-available polylactic acid having a weight average molecular weight (Mw) of about 200,000 is generally kneaded at a temperature 10 to 20 degrees C. higher than the melting point of the polylactic acid. On the other hand, in the present disclosure, such a polylactic acid can be kneaded at a temperature lower than the melting point of the polylactic acid, especially at a relatively high viscosity at a temperature lower than the melting point. Specifically, the temperature is from −20 to −80 degrees C., more preferably from −30 to −60 degrees C. The temperature may be simply set with reference to the current value of the stirring power of the apparatus. However, it can be said that these set values are in a range that can be reached only in the present disclosure.

### Compressible Fluid Removal Area

After the kneading, the compressible fluid is removed by releasing the pressure. The temperature at the time of removing the compressible fluid is preferably set to a temperature equal to or higher than the melting point of the resin.

### Mold Processing Area

The aliphatic polyester resin composition according to an embodiment of the present invention is manufactured by a conventionally-known method for manufacturing a thermoplastic resin. For example, a T-die is used for processing into a sheet.

### Aliphatic Polyester Resin Composition

The aliphatic polyester resin composition according to an embodiment of the present invention is suitably manufactured by the method of manufacturing an aliphatic polyester resin composition according to an embodiment of the present invention.

The aliphatic polyester resin composition according to an embodiment of the present invention contains an aliphatic polyester resin and a filler, and may further contain other components as necessary.

The aliphatic polyester resin composition according to an embodiment of the present invention, after kneading, preferably has the following properties.
Containing a filler in an amount of 0.1% by mass or more and 10% by mass or less.
The number average particle diameter of the filler is 0.01 μm or more and less than 0.20 μm.
The standard deviation of the number average particle diameter of the filler is 0.3 or less.
The number of coarse particles of the filler having a particle diameter of 10 μm or more is 10 or less per 1 mm² of the aliphatic polyester resin composition.

The term “after kneading” not only refers to “after a kneading operation of a polylactic acid and a filler” to produce a polylactic acid composition, but also refers to “after a polymerization reaction of lactide (monomer) in the presence of a filler” to produce a polylactic acid composition.

In the initial stage of the reaction in which a lot of monomers are present in a reaction system, the melt viscosity is very low and there is almost no effect of dispersing the filler. Dispersion of the filler proceeds from the latter stage of the polymerization to after completion of the polymerization reaction in which the monomer has been consumed. Since the viscosity suitable for kneading the filler and the viscosity during the polymerization reaction are different, the polylactic acid composition obtained by a polymerization reaction of lactide in the presence of the filler also corresponds to the composition after kneading. Therefore, in the present disclosure, a polylactic acid composition after kneading is synonymous with a polylactic acid into which a filler has been introduced.

### Method of Manufacturing Product

A method of manufacturing a product according to an embodiment of the present invention includes the method of manufacturing the aliphatic polyester resin composition according to an embodiment of the present invention.

That is, the product according to an embodiment of the present invention contains the aliphatic polyester resin composition according to an embodiment of the present invention, and may further contain other components as necessary.

Examples of the product include, but are not limited to, molded products, sheets, films, particles, fibers, and foams.

### Molded Product

The molded product is a product obtained by processing the aliphatic polyester resin composition according to an embodiment of the present invention using a mold. In the present disclosure, the molded product includes not only a single body of the molded product, but also a part consisting of the molded product such as a tray handle and a product equipped with a tray with a handle attached as the molded product.

The processing method using a mold is not particularly limited, and a conventionally-known method for processing thermoplastic resins can be used, such as injection molding, vacuum molding, pressure molding, vacuum pressure molding, and press molding.

The molded product can be obtained by melting the aliphatic polyester resin composition according to an embodiment of the present invention and subjecting it to injection molding. The molded product can also be obtained by forming (giving a shape to) a sheet made of the aliphatic polyester resin composition according to an embodiment of the present invention by press molding using a mold.

The processing conditions for forming are appropriately determined based on the type of the aliphatic polyester resin composition according to an embodiment of the present invention, the apparatus, and the like. For example, in the case of forming a sheet made of the aliphatic polyester resin composition according to an embodiment of the present invention by press molding using a mold, the mold temperature may be set to 100 degrees C. or higher and 150 degrees C. or lower. In the case of forming by injection molding, the aliphatic polyester resin composition according to an embodiment of the present invention may be heated to 150 degrees C. or higher and 250 degrees C. or lower and injected into a mold whose temperature is set to 20 degrees C. or higher and 80 degrees C. or lower.

A conventional aliphatic polyester resin composition containing a filler has a drawback that the degree of dispersion of the filler is insufficient, so that the effect of introducing the filler is poor and mechanical properties such as strength is poor when the composition is formed into a sheet.

The molded product formed from the aliphatic polyester resin composition according to an embodiment of the present invention has excellent sheet properties such as mechanical strength, and provides wide applications such as sheets, packaging materials, and trays in the field of industrial materials, daily necessities, agricultural products, food products, pharmaceutical products, cosmetics, etc.

The aliphatic polyester resin composition according to an embodiment of the present invention is useful for biodegradable applications, particularly for packaging materials for foods, cosmetics, and medical sheets for pharmaceuticals. When the sheets are further thinned by improvement of dispersibility of the filler, it is expected that the performance is further improved.

### Particle

The aliphatic polyester resin composition according to an embodiment of the present invention can be formed into particles by pulverizing the aliphatic polyester resin composition by a conventionally-known method.

The particle diameter of the particles is not particularly limited and can be suitably selected to suit to a particular application, but is preferably 1 μm or more and 50 μm or less.

When the particles are used as an electrophotographic toner, a mixture in which a colorant and a hydrophobic particle are mixed in the aliphatic polyester resin composition is prepared. The mixture may further contain other additives in addition to a binder resin, the colorant, and the hydrophobic particle. Examples of the other additives include, but are not limited to, release agents and charge controlling agents. The process of mixing the additives may be either simultaneous with or after the polymerization reaction. Alternatively, the additives may be added after the polymerization product has been taken out while being melt-kneaded.

### Film

The film is obtained by forming the aliphatic polyester resin composition according to an embodiment of the present invention into a thin film, and has a thickness of less than 250 μm. The film is produced by stretch-molding the aliphatic polyester resin composition according to an embodiment of the present invention.

The method of stretch molding is not particularly limited. Examples thereof include, but are not limited to, uniaxial stretch molding methods applicable to stretch molding of general-purpose plastics, and simultaneous or sequential biaxial stretch molding methods (e.g., tubular method, Tenter method).

The stretch molding is usually performed at a temperature range of from 150 to 280 degrees C. The molded film is subjected to uniaxial or biaxial stretching by a roll method, a Tenter method, a tubular method, or the like. The stretching temperature is preferably from 30 to 110 degrees C., more preferably from 50 to 100 degrees C. The stretching ratio is preferably from 0.6 to 10 times in each of the longitudinal and lateral directions. After stretching, heat treatments may be performed such as blowing hot air, irradiating infrared rays, irradiating microwaves, or bringing into contact with a heat roll.

By such a stretch molding method, various stretched films can be obtained such as stretched sheets, flat yarns, stretched tapes, stretched bands, streaked tapes, and split yarns. The thickness of the stretched film is not particularly limited and can be suitably selected to suit to a particular application, but is preferably 5 μm or more and less than 250 μm.

The molded stretched film may also be subjected to a secondary processing for the purpose of imparting surface functions such as chemical function, electrical function, magnetic function, mechanical function, friction function, wear function, lubrication function, optical function, thermal function, and biocompatibility. Examples of the secondary processing include, but are not limited to, embossing, painting, adhesion, printing, metallizing (e.g., plating), machining, and surface treatments (e.g., antistatic treatment, corona discharge treatment, plasma treatment, photochromism treatment, physical vapor deposition, chemical vapor deposition, coating).

The stretched films provide wide applications such as daily necessities, packaging materials, pharmaceuticals, electrical equipment materials, home appliance housings, and automobile materials.

### Sheet

The sheet is obtained by forming the aliphatic polyester resin composition according to an embodiment of the present invention into a thin film, and has a thickness of 250 μm or more.

The sheet can be obtained by subjecting the aliphatic polyester resin composition according to an embodiment of the present invention to a conventionally-known method for manufacturing a sheet of a thermoplastic resin. The method for manufacturing the sheet is not particularly limited and can be suitably selected to suit to a particular application. Examples thereof include, but are not limited to, T-die methods, inflation methods, and calendar methods.

The sheet processing conditions are not particularly limited and appropriately determined based on the type of the aliphatic polyester resin composition, the apparatus, and the like. For example, in the case of processing polylactic acid by a T-die method, the heated aliphatic polyester resin composition may be extruded from a T-die attached to the outlet of an extrusion molding machine to be formed into a sheet. The heating temperature of the aliphatic polyester resin composition is preferably 150 degrees C. or higher and 250 degrees C. or lower.

### Fiber

The aliphatic polyester resin composition according to an embodiment of the present invention is also applicable to fibers such as monofilaments and multifilaments. In the present disclosure, the fiber includes not only single filaments (e.g., monofilaments) but also intermediate products (e.g., woven fabrics and nonwoven fabrics) comprising of fibers and products (e.g., masks) containing woven fabrics and nonwoven fabrics.

In the case of monofilaments, the fiber is produced by fiberizing the aliphatic polyester resin composition according to an embodiment of the present invention by conventionally-known processes of melt spinning, cooling, and stretching. Depending on the application, a coating layer may be formed on the monofilament by a conventionally-known method. The coating layer may contain an antibacterial agent, a colorant, and the like. In the case of nonwoven fabrics, conventionally-known processes of melt spinning, cooling, stretching, opening, depositing, and heat treatments may be performed.

### Foam

The foam is obtained by foaming the aliphatic polyester resin composition according to an embodiment of the present invention. In the present disclosure, the foam includes not only a single body of the foam such as a foam resin, but also a part containing the foam, such as a heat insulating material and a soundproofing material, and a product containing a foam such as a building material.

The foam may be produced by reducing the temperature and pressure of the aliphatic polyester resin composition dissolved or plasticized in the compressible fluid and utilizing vaporization of the compressible fluid in the aliphatic polyester resin composition. It is considered that the compressible fluid in the aliphatic polyester resin composition according to an embodiment of the present invention diffuses at a rate of 10⁻⁵/sec to 10⁻⁶/sec when exposed to the atmosphere. When the pressure of the compressible fluid is released, the temperature drops due to the constant enthalpy, which may make it difficult to control the cooling rate. Even in this case, if the elasticity of the polymer is large when the polymer is open to the atmosphere, bubbles are maintained and a foam is formed.

The foam may be produced by directly injecting a predetermined amount of the aliphatic polyester resin composition dissolved or plasticized in a compressible fluid into a mold, reducing the pressure, and subjecting the composition to heat molding. The heating may be performed with, for example, steam, conduction heat, radiant heat, or microwaves. In this case, the composition is heated with these heating sources to about 100 to 140 degrees C., preferably heated with steam to 110 degrees C. to 125 degrees C., for foam molding.

The foam can also be produced by applying a general method for producing a foamable plastic to the aliphatic polyester resin composition according to an embodiment of the present invention. In this case, desired additives, such as a modifier and a nucleating agent, are blended into the aliphatic polyester resin composition according to an embodiment of the present invention, then the composition is extruded by a general melt extruder to obtain a strand. After that, the obtained strand is formed into pellets or particles using a pelletizer (“particle formation process”). The particles or pellets are put in an autoclave then put into a gas phase or a liquid phase such as water or pure water, optionally with any conventional additive, to prepare a resin particle liquid dispersion. Examples of the additive include, but are not limited to, dispersants, anti-fusion agents, and anti-adhesion agents. Further, the resin particle liquid dispersion is allowed to foam using a volatile foaming agent to obtain foamed particles (“foaming process”). The particles are exposed to the atmosphere to allow the air to permeate the bubbles of the particles, and if necessary, the water adhering to the particles is removed (“aging process”). Next, the foamed particles are put inside a closed mold provided with small holes or slits, then heated and foamed, whereby individual particles can be fused and integrated into a product.

The obtained foam provides wide applications such as cushioning materials, heat insulating materials, soundproofing materials, and vibration damping materials.

### EXAMPLES

Further understanding can be obtained by reference to certain specific examples which are provided herein for the purpose of illustration only and are not intended to be limiting.

### Example 1

Using the continuous kneading apparatus 100 illustrated in FIG. 3, an aliphatic polyester resin and a filler were supplied at a flow rate of 10 kg/hr in total. A polylactic acid (REVODE190 manufactured by Zhejiang Hisun Pharmaceutical Co., Ltd., having a melting point of 178 degrees C.) as an aliphatic polyester resin, a titanium oxide (TTO-55 manufactured by Ishihara Sangyo Kaisha, Ltd.) as a filler, and carbon dioxide as a compressible fluid were respectively supplied at 9.9 kg/hr, 0.1 kg/hr, and 0.99 kg/hr (corresponding to 10% by mass of the polylactic acid) and kneaded to obtain a resin composition and a sheet.

The temperature in each zone was as follows: 190 degrees C. in the raw material mixing and melting area (a) and the compressible fluid supply area (b), 150 degrees C. in the kneading area (c), 190 degrees C. in the compressible fluid removal area (d), and 190 degrees C. in the mold processing area (e). The pressure in each zone was as follows: 7.0 MPa from the compressible fluid supply area (b) to the kneading area (c), 0.5 MPa in the compressible fluid removal area (d), and 5 MPa in the T-die 4. The thickness of the sheet was 300 μm.

### Examples 2 to 5 and Comparative Example 1

A resin composition and a sheet were prepared in the same manner as in Example 1 except that the feed ratio (polylactic acid/titanium oxide) and the kneading temperature were changed according to the descriptions in Tables 1, 2, and 4.

### Examples 6 to 7 and Comparative Example 2

A resin composition and a sheet were prepared in the same manner as in Example 1 except that the amount of compressible fluid was changed according to the descriptions in Tables 1, 2, and 4.

### Examples 8 to 11 and Comparative Example 3

A resin composition and a sheet were prepared in the same manner as in Example 1 except that the filler was replaced with the material below.

Example 8: Silica (QSG-30 having a number average particle diameter of 0.03 μm, manufactured by Silicone Division of Shin-Etsu Chemical Co., Ltd.)

Example 9: Silica (QSG-10 having a number average particle diameter of 0.015 μm, manufactured by Silicone Division of Shin-Etsu Chemical Co., Ltd.)

Example 10: Silica (QSG-100 having a number average particle diameter of 0.11 μm, manufactured by Silicone Division of Shin-Etsu Chemical Co., Ltd.)

Example 11: Trimethylstearylammonium bentonite (KUNIVIS 110 manufactured by KUNIMINE INDUSTRIES CO., LTD.)

Comparative Example 3: Ground calcium carbonate (SOFTON 2200 having a number average particle diameter of 1.0 μm, manufactured by Shiraishi Calcium Kaisha, Ltd.)

### Example 12

A resin composition and a sheet were prepared in the same manner as in Example 1 except that the polylactic acid was replaced with polybutylene succinate (having a melting point of 115 degrees C., manufactured by PTT MCC Biochem Co., Ltd.) and the kneading temperature was changed to 100 degrees C.

### Example 13

The polylactic acid used in Example 1 was replaced with a polyglycolic acid (PGA) (KUREDUX 100E35 manufactured by KUREHA CORPORATION, having a melting point 220 degrees C.).

A resin composition and a sheet were prepared in the same manner as in Example 1 except that the method of supplying the compressible fluid in the kneading operation and the temperature and pressure in each zone were changed as follows.

In the kneading operation, carbon dioxide as the first compressible fluid and dimethyl ether as the second compressible fluid were each supplied at 0.25 kg/hr.

The temperature in each zone was as follows: 230 degrees C. in the raw material mixing and melting area (a) and the compressible fluid supply area (b), 150 degrees C. in the kneading area (c), 230 degrees C. in the compressible fluid removal area (d), and 230 degrees C. in the mold processing area (e). The pressure in each zone was as follows: 7.0 MPa from the compressible fluid supply area (b) to the kneading area (c), 0.5 MPa in the compressible fluid removal area (d), and 5 MPa in the T-die 4.

### Method of Measuring Proportion of Aliphatic Polyester Resin

The proportion of the aliphatic polyester resin was measured by the following GC-MS (gas chromatography-mass spectrometry) analysis, by comparison with a known aliphatic polyester resin as a standard sample. The measurement results are presented in Tables 1 to 4.

### GC-MS Analysis

GC-MS: QP2010 manufactured by Shimadzu Corporation, auxiliary equipment: Py3030D manufactured by Frontier Laboratories Ltd.
Separation column: Ultra ALLOY UA5-30M-0.25F manufactured by Frontier Laboratories Ltd.
Sample heating temperature: 300 degrees C.
Column oven temperature: 50 degrees C. (hold for 1 minute)->temperature rise at 15 degrees C./min->320 degrees C. (6 minutes)
Ionization method: Electron Ionization (E.I.) method
Detected mass range: 25 to 700 (m/z)

### Number Average Particle Diameter and Standard Deviation (σ) of Filler

A sheet made of the aliphatic polyester resin composition was subjected to a cross-section processing using an ion milling device (IM4000 PLUS manufactured by Hitachi High-Technologies Corporation), and the cross-section was observed with a SEM (scanning electron microscope).

The obtained SEM image of the cross-section (with a magnification of 10,000 times) was binarized into white components, corresponding to the filler, and resin components using a software program IMAGE-PRO PREMIER (made by Media Cybernetics, Inc.). After that, a particle diameter (Feret diameter) of each white component (filler) was determined in a 35 μm×20 μm range in the above image, then the number average particle diameter and standard deviation (σ) were calculated from the white components (filler) which have a Feret diameter of 0.05 μm or more. These values obtained in three fields of view are averaged and presented in Tables 1 to 4 as the measurement results. Since several hundreds or more particles were observed per field of view, one field of view provides a measurement result of several hundreds or more particles.

### Measurement of Number of Coarse Particles of Filler

The number (particles/g) of coarse particles of the filler having a particle diameter of 10 μm or more was counted in each of ten 1-mm² fields of view in the SEM image of the cross-section, and the counted values were averaged. The measurement results are presented in Tables 1 to 4.

TABLE 1

| | | Example 1 | Example 2 | Example 3 | Example 4 |
|---|---|---|---|---|---|
| Aliphatic | Type | Polylactic | Polylactic | Polylactic | Polylactic |
| polyester | | acid | acid | acid | acid |
| resin | | | | | |
| Proportion of aliphatic polyester | | 100% by mass | 100% by mass | 100% by mass | 100% by mass |
| resin to total organic matter | | | | | |
| Filler | Type | Titanium | Titanium | Titanium | Titanium |
| | | oxide | oxide | oxide | oxide |
| | Number average | 0.03 | 0.03 | 0.03 | 0.03 |
| | particle | | | | |
| | diameter (μm) | | | | |
| Feed ratio (aliphatic polyester | | 99/1 | 97.5/2.5 | 95/5 | 90/10 |
| resin/filler) | | | | | |
| Compressible | Type | Carbon | Carbon | Carbon | Carbon |
| fluid | | dioxide | dioxide | dioxide | dioxide |
| | Supply amount | 10% by mass | 10% by mass | 10% by mass | 10% by mass |
| | (to aliphatic | | | | |
| | polyester resin) | | | | |
| Kneading | Temperature | 150 | 150 | 150 | 150 |
| process | (deg. C.) | | | | |
| | Pressure (MPa) | 7.0 | 7.0 | 7.0 | 7.0 |
| Filler of | Number average | 0.04 | 0.06 | 0.06 | 0.09 |
| aliphatic | particle | | | | |
| polyester | diameter (μm) | | | | |
| resin | Standard | 0.02 | 0.04 | 0.05 | 0.08 |
| composition | deviation (σ) | | | | |
| after | Number of coarse | 0.3 | 1.2 | 1.8 | 3.2 |
| kneading | particles | | | | |
| | (number/mm²) | | | | |

TABLE 2

| | | Example 5 | Example 6 | Example 7 | Example 8 |
|---|---|---|---|---|---|
| Aliphatic | Type | Polylactic | Polylactic | Polylactic | Polylactic |
| polyester | | acid | acid | acid | acid |
| resin | | | | | |
| Proportion of aliphatic polyester | | 100% by mass | 100% by mass | 100% by mass | 100% by mass |
| resin to total organic matter | | | | | |
| Filler | Type | Titanium | Titanium | Titanium | Silica |
| | | oxide | oxide | oxide | |
| | Number average | 0.03 | 0.03 | 0.03 | 0.03 |
| | particle | | | | |
| | diameter (μm) | | | | |
| Feed ratio (aliphatic polyester | | 99/1 | 99/1 | 99/1 | 99/1 |
| resin/filler) | | | | | |
| Compressible | Type | Carbon | Carbon | Carbon | Carbon |
| fluid | | dioxide | dioxide | dioxide | dioxide |
| | Supply amount | 10% by mass | 5% by mass | 3% by mass | 10% by mass |
| | (to aliphatic | | | | |
| | polyester resin) | | | | |
| Kneading | Temperature | 120 | 150 | 150 | 150 |
| process | (deg. C.) | | | | |
| | Pressure (MPa) | 12 | 7 | 7 | 7 |
| Filler of | Number average | 0.03 | 0.04 | 0.04 | 0.12 |
| aliphatic | particle | | | | |
| polyester | diameter (μm) | | | | |
| resin | Standard | 0.02 | 0.02 | 0.02 | 0.08 |
| composition | deviation (σ) | | | | |
| after | Number of coarse | 0.1 | 0.4 | 0.4 | 0.2 |
| kneading | particles | | | | |
| | (number/mm²) | | | | |

TABLE 3

| | | Example 9 | Example 10 | Example 11 | Example 12 |
|---|---|---|---|---|---|
| Aliphatic | Type | Polylactic | Polylactic | Polylactic | Polybutylene |
| polyester | | acid | acid | acid | succinate |
| resin | | | | | |
| Proportion of aliphatic polyester | | 100% by mass | 100% by mass | 100% by mass | 100% by mass |
| resin to total organic matter | | | | | |
| Filler | Type | Silica | Silica | Trimethyl- | Titanium |
| | | | | stcaryl- | oxide |
| | | | | ammonium | |
| | | | | bentonite | |
| | Number average | 0.015 | 0.11 | — | 0.03 |
| | particle | | | | |
| | diameter (μm) | | | | |
| Feed ratio (aliphatic polyester | | 99/1 | 99/1 | 99/1 | 99/1 |
| resin/filler) | | | | | |
| Compressible | Type | Carbon | Carbon | Carbon | Carbon |
| fluid | | dioxide | dioxide | dioxide | dioxide |
| | Supply amount | 10% by mass | 10% by mass | 10% by mass | 10% by mass |
| | (to aliphatic | | | | |
| | polyester resin) | | | | |
| Kneading | Temperature | 150 | 150 | 150 | 150 |
| process | (deg. C.) | | | | |
| | Pressure (MPa) | 7 | 7 | 7 | 7 |
| Filler of | Number average | 0.18 | 0.12 | 0.15 | 0.08 |
| aliphatic | particle | | | | |
| polyester | diameter (μm) | | | | |
| resin | Standard | 0.15 | 0.09 | 0.21 | 0.06 |
| composition | deviation (σ) | | | | |
| after | Number of coarse | 4.5 | 1.2 | 5.2 | 0.6 |
| kneading | particles | | | | |
| | (number/mm²) | | | | |

TABLE 4

| | | | Comparative | Comparative | Comparative |
|---|---|---|---|---|---|
| | | Example 13 | Example 1 | Example 2 | Example 3 |
| Aliphatic | Type | Polyglycolic | Polylactic | Polylactic | Polylactic |
| polyester | | acid | acid | acid | acid |
| resin | | | | | |
| Proportion of aliphatic polyester | | 100% by mass | 100% by mass | 100% by mass | 100% by mass |
| resin to total organic matter | | | | | |
| Filler | Type | Titanium | Titanium | Titanium | Calcium |
| | | oxide | oxide | oxide | carbonate |
| | Number average | 0.03 | 0.03 | 0.03 | 0.4 |
| | particle | | | | |
| | diameter (μm) | | | | |
| Feed ratio (aliphatic polyester | | 99/1 | 99/1 | 99/1 | 99/1 |
| resin/filler) | | | | | |
| Compressible | Type | Carbon dioxide/ | Carbon dioxide | None | None |
| fluid | | Dimethyl ether | | | |
| | Supply amount | 10% by mass | 10% by mass | None | None |
| | (to aliphatic | | | | |
| | polyester resin) | | | | |
| Kneading | Temperature | 150 | 190 | 190 | 190 |
| process | (deg. C.) | | | | |
| | Pressure (MPa) | 7 | 2 | 0 | 0 |
| Filler of | Number average | 0.12 | 0.42 | 0.38 | 0.35 |
| aliphatic | particle | | | | |
| polyester | diameter (μm) | | | | |
| resin | Standard | 0.09 | 0.28 | 0.26 | 0.42 |
| composition | deviation (σ) | | | | |
| after | Number of coarse | 0.9 | 15 | 12 | 25 |
| kneading | particles | | | | |
| | (number/mm²) | | | | |

It is clear from the above results that, in Examples 1 to 13 in each of which kneading was performed at a temperature lower than the melting point of the aliphatic polyester resin in the presence of a compressible fluid, the number average particle diameter, standard deviation, and number of coarse particles of the filler in the aliphatic polyester resin composition after kneading are small. Thus, aliphatic polyester resin compositions in which the filler is well dispersed were obtained. By contrast, in Comparative Example 1 in which kneading was performed at a temperature higher than the melting point of the aliphatic polyester resin, the number average particle diameter, standard deviation, and number of coarse particles of the filler in the aliphatic polyester resin composition after kneading are large. Comparative Example 1 indicates that the filler is not well dispersed in the aliphatic polyester resin composition. It is considered that this is because the compressible fluid was not in the critical state and the temperature at the time of kneading was high, so that the viscosity of the polylactic acid became low, the force for kneading the filler was weak, and the filler got aggregated. In Comparative Examples 2 and 3 in each of which no compressible fluid was used, the filler got aggregated during kneading, failed to provide an aliphatic polyester resin composition in which the filler was well dispersed.

Numerous additional modifications and variations are possible in light of the above teachings. It is therefore to be understood that, within the scope of the above teachings, the present disclosure may be practiced otherwise than as specifically described herein. With some embodiments having thus been described, it will be obvious that the same may be varied in many ways. Such variations are not to be regarded as a departure from the scope of the present disclosure and appended claims, and all such modifications are intended to be included within the scope of the present disclosure and appended claims.

1. A method of manufacturing an aliphatic polyester resin composition, comprising:
kneading an aliphatic polyester resin and a filler at a temperature lower than a melting point of the aliphatic polyester resin in the presence of a compressible fluid.

2. The method of claim 1, wherein the temperature is lower than the melting point of the aliphatic polyester resin by 20 degrees C. or more.

3. The method of claim 1, wherein a ratio of the aliphatic polyester resin to the filler is from 99/1 to 90/10.

4. The method of claim 1, wherein a proportion of the compressible fluid to the aliphatic polyester resin is from 3% to 10% by mass.

5. The method of claim 1, wherein the filler has a number average particle diameter of 0.01 μm or more and 0.20 μm or less.

6. The method of claim 1, wherein the aliphatic polyester resin comprises a polylactic acid.

7. The method of claim 1, wherein the filler has a spherical shape.

8. The method of claim 1, wherein the compressible fluid comprises carbon dioxide.

9. The method of claim 1, wherein the filler comprises a silica.

10. A product comprising the aliphatic polyester resin composition manufactured by the method of claim 1.

11. The product of claim 10, wherein the product is at least one member selected from the group consisting of molded products, sheets, films, particles, fibers, and foams.
